(19) United States
(12) Patent Application Publication
(10) Pub. No.: US 2007/0174762 A1
(43) Pub. Date: Jul. 26, 2007

(54) Personal web page annotation system

(75) Inventor: Laurence John Plant, North Uglwyn (AU)

Correspondence Address: BOND SCHOENECK & KING, PLLC, ONE LINCOLN CENTER, SYRACUSE, NY, 13202, US

(73) Assignee: International Business Machines Corporation, Armonk, NY (US)

(21) Appl. No.: 11/338,403

(22) Filed: Jan. 24, 2006

(51) Int. Cl. G06F 17/00

(52) U.S. Cl. 715/512

(57) ABSTRACT

An annotation service that is functionally deployed between a web browser and a web server, and in communication with at least the web browser. The annotation service provides tools, methods, and infrastructure to permit existing unmodified web content published via any URL as static or dynamic web pages to be displayed and annotated in existing browsers, with the annotation data being stored on the network relative to the web page.

### BACKGROUND OF THE INVENTION

1. Field of Invention

The present invention relates to systems for permitting a user to annotate digital content, and more specifically to systems that are functionally disposed between a web browser and web server and in communication with at least the web browser and provide a user with tools for annotating web pages personal to that user.

2. Description of Prior Art

With paper based documents, people have long been accustomed to using writing instruments or other indicia to annotate the document. Types of annotation include highlighting, underlining, and circling key phrases or diagrams and adding text or symbols to the document for commentary purposes. The annotations permit the annotator and others reading the document to quickly identify key parts of the document, and take whatever action may be necessary relative to the data.

Several commercially available word processors and word processing software systems incorporate tools that enable editors to annotate and comment on parts of a document. These annotation tools are specific to the word processing package, however, and do not support annotation of documents which are published on the web or other open network.

Despite that fact that billions of pages worth of content are now published on the Internet, tools for annotating web pages (“web pages” being understood to mean digital documents available on a network, including an open network like the Internet) are not in widespread use. The web has focused on publishing pages for viewing, not publishing pages for reviewing, and thus annotation tools for web pages have not been developed with the type of functionality that makes them useful to everyday users of the web.

Annotation of web pages can enhance the readability and relevance of content in many ways. Individual users can record key data about the document that is not already stored in the document. For example, a bank account statement published on the web will show the date, an amount and a brief description of the transaction. Annotation will permit the user to highlight key transactions and make comment on them, for example, recording that the bank was notified the charge may be fraudulent and that a response is needed from the bank. If annotated, it would also be useful when returning to the web based account statement in the future that the annotation be able to be seen by the user so he/she may immediately focus on the annotation.

It would also be useful if the annotation could be shared with others, enabling subsequent readers to better understand and focus on key parts of the document. For example, a house plan that two different people in different locations and at different times are reviewing together.

Web based annotation tools that presently exist do not adequately address several challenges. For instance, it is desirable that existing web servers not have to be reconfigured, rearchitectured, or extended in order for their pages to be annotated. It would also be beneficial to make it unnecessary for web browsers to be upgraded or require proprietary vendor extensions in order to support annotation.

Increasingly, web pages are dynamic in nature. That is, they are built for the user when the user requests them, and so it is possible that no two web pages will be identical for the same user viewing the same page at different times. While dynamic web pages make the content being published more relevant to the user, they also make the task of recording an annotation and matching it to the correct point in the published page more difficult.

3. Objects and Advantages

It is therefore a principal object and advantage of the present invention to provide a web page annotation service that functionally exists between a web browser and a web server and permits annotation to dynamic and/or static web pages that can be saved to the network.

It is another object and advantage of the present invention to provide a web page annotation service that does not require reconfiguring web servers, nor upgrading of web browsers.

It is a further object and advantage of the present invention to provide a web page annotation service that relates the annotations made to a particular field on a web page rather than a location on a web page.

Other objects and advantages of the present invention will in part be obvious and in part appear hereinafter.

### SUMMARY OF THE INVENTION

In accordance with the foregoing objects and advantages, the present invention provides an annotation service that is communicatively deployed between a web browser and a web server, and that provides tools, methods, and infrastructure to permit existing unmodified web content published via any URL as static or dynamic web pages to be displayed and annotated in existing browsers, with the annotation data being stored relative to the web page.

In one aspect, the present invention provides a system for annotating a web page, comprising a web page server, a web browser adapted to communicate with and request a predetermined web page from the web server, and a web page annotation system communicatively positioned between said web server and said web browser. The annotation system, in turn, comprises an annotation server adapted to communicate with the web page server and the web browser, a pattern matcher adapted to communicate with the annotation server, and an annotation database adapted to communicate with the annotation server.

In another aspect of the present invention, the web browser includes a plug-in that functionally redirects web pages received directly from a web server to the annotation server for processing in accordance with the present invention.

A method for annotating a web page utilizing the present invention includes the steps of identifying a user in response to a logon request from the user, intercepting a response from a web server from which a web page has been requested by the user; determining if annotation data for the user is stored relative to the web page, and providing the web page with any of the annotation data displayed thereon to the user.

The web page annotation service contemplated by the present invention can be deployed in several alternate architectures and with our without encryption or other security between the browser and the annotation service. Among the architectures contemplated are: the web page annotation service positioned at an intermediary positioned between the web browser and web server with or without encrypted connections between the browser and annotation service; the web page annotation service as a servlet (a “servlet” is a term of art and is a server-side program typically written in Java that provides additional features to the server) of the web server with encryption between the annotation service and the web browser; the annotation service as a dedicated server, with encryption, with the browser unencrypting responses received from the web server and redirecting the responses to the annotation service via a plug-in; and the annotation service as an embedded service within a user's computing device with a plug-in that redirects responses received by the browser from the web server to the annotation service for processing.

### BRIEF DESCRIPTION OF THE DRAWINGS

The present invention will be more fully appreciated and understood by reading the following Detailed Description in conjunction with the accompanying drawings, in which:

FIG. 1 is a high level schematic view of an annotation service for web pages.

FIG. 2 is a high level schematic view of the annotation service incorporating data structures.

FIG. 3 is a flow chart for the storage and viewing of annotations.

FIG. 4 is a screen display of a user interface for an annotation tool kit overlaid on an existing unmodified web page.

FIG. 5 is a screen shot illustrating user annotation done to a web page by highlighting the field to be annotated.

FIG. 6 is a screen shot illustrating user annotation consisting of the addition of text to a web page.

FIG. 7 is a screen shot illustrating a web page that has annotations stored relative thereto and identifying for a user that an annotation exists.

FIG. 8 is a screen shot of the same dynamic web page as illustrated in FIG. 7 but as it exists in a subsequent user access thereof.

FIG. 9 is a screen shot of the web page of FIG. 8 after the user accesses and views the annotation.

FIGS. 10A-10E are high level schematics representing alternate deployment architectures for the annotation service.

### DETAILED DESCRIPTION

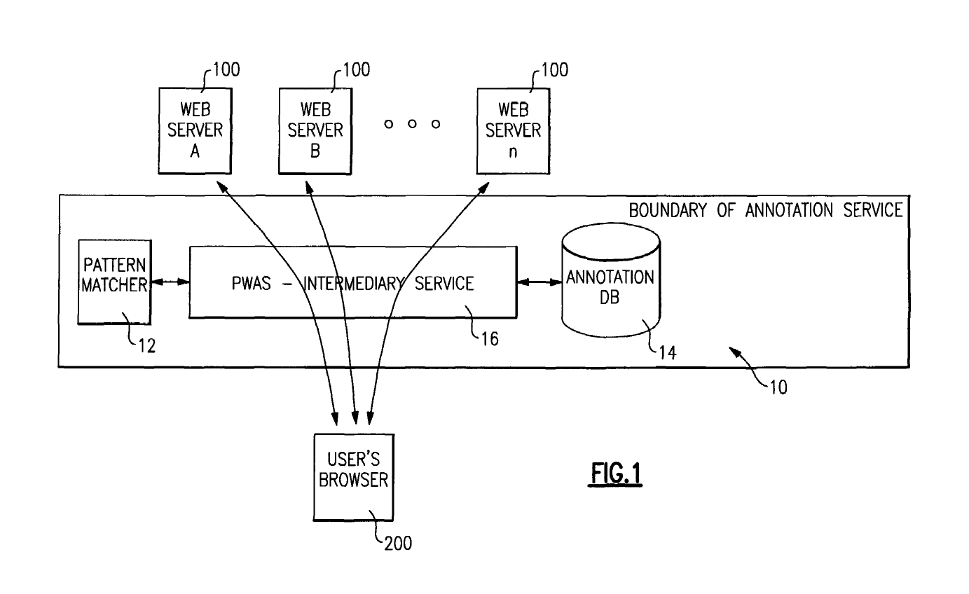

Referring now to the drawings, in which like reference numerals refer to like parts throughout, there is seen in FIG. 1, an annotation service, designated generally by reference numeral 10, communicatively positioned between any number of web servers, each designated 100, and a user's web browser 200. In this intermediary position, annotation service 10 is adapted to intercept requests made from browser 200 to any of web servers 100 or from any of the web servers 100 to browser 200.

In operation, the responses being sent by the web server 100 that are intercepted by annotation service 10 are examined and compared with a library or database of existing annotations stored in database 12 using a pattern matcher 14 which is a text search engine. The pattern matcher 14 identifies when pages being served to browser 200 have annotations and at what position on the page the annotation belongs. Annotation service 10 overlays the annotations on the page and then serves it via an annotation server 16 to the browser 200 for display to the user.

As will be described in further detail hereinafter, users view dynamic and/or static web pages in their browser 200 and then use the annotation tools to make the annotations on the page they are viewing on browser 200. The user then requests that the annotations be saved in annotation service 10 using a save function. This save request passes from browser 200 to annotation server 16 where the user annotation is stored in a database 12 for subsequent retrieval and comparison with pages being sent to the user from a web server 100.

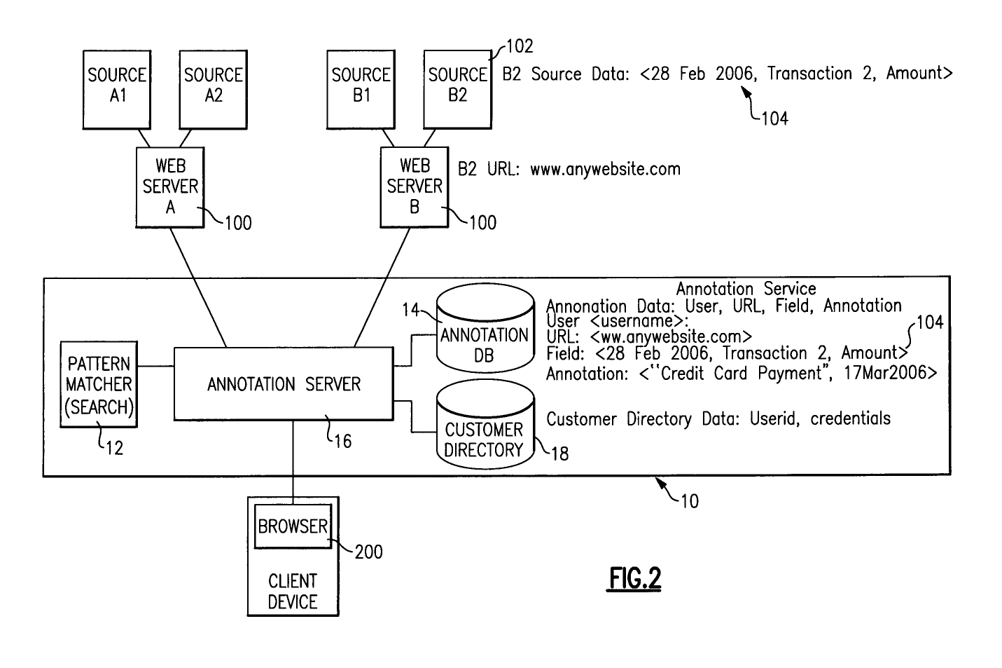

Referring now to FIG. 2, an expansion of the system illustrated in FIG. 1 is provided. Annotation service 10 further includes a customer directory database 18 in communication with annotation server 16 that stores user identification and credential data, such as a password, for example. This data is used to enroll and authenticate users at runtime to ensure that individual users can only access annotations they are authorized to view and modify.

Additionally, in the system of FIG. 2, web servers 100 publish data that has been sourced or aggregated from multiple sources 102 (e.g., databases or application servers). As shown, web server B has URL www.anywebsite.com, and it is sourcing a set of transaction data from sources B1 and B2. The transaction data of source B2 includes a field 104 which the user has annotated. Source B2, however, has no record that the field 104 has been annotated. Web server 100 (B) will receive and aggregate the field and other transaction data with further content and publish it to the user, but the field will first be annotated by annotation service 10.

As shown in FIG. 2, the full annotation record 20 for this transaction is illustrated. Record 20 comprises the user's details, the URL for the web server which has been annotated (www.anywebsite.com), the field 104 which has been annotated (transaction dated 28 Feb. 2006). In addition, the record 20 shows the annotation itself, both the text (<“Credit Card Payment”, 17 Mar. 2006>) and the visual effect (<“red ellipse”>). The matching of this stored annotation with the content being served to the user is undertaken by pattern matcher 12.

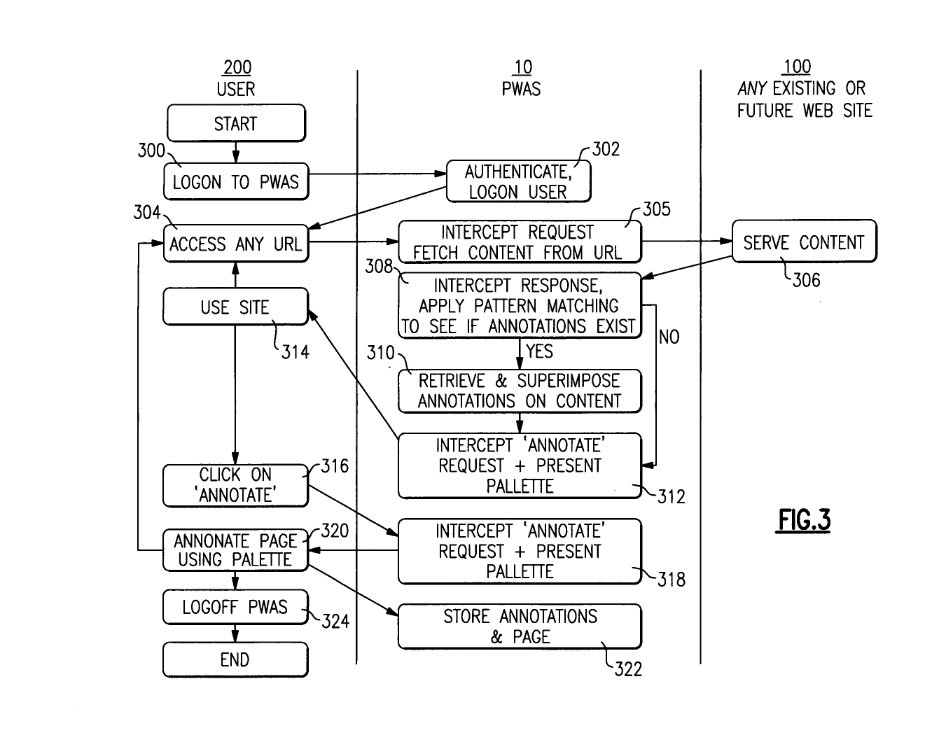

With reference now to FIG. 3, the sequence of steps where a user logs onto and uses annotation service 10 to both retrieve and store annotations is provided. First, the user provides logon information which is transmitted to annotation service 10 in step 300. The annotation service then authenticates the user in step 302 before the user can begin using annotation service 10. The user is then free to access any URL in step 304, and the web server 100 will serve its content, step 306, and the response is intercepted by the annotation service 10 in step 305 and it retrieves the content from the URL which then serves its content in step 306, which is then intercepted by annotation service in step 308 where it then applies pattern matching to see if annotations are stored for this user for this URL. If so, annotation service 10 invokes pattern matcher 12 to identify where in the page the annotations are to be overlaid and the change to the page is made in step 310. The page is then presented back to the user in step 312 via annotation server 16. The user can then view the page on his/her browser 200 in step 314 and can elect to view another site (back to step 304), or use the annotation toolkit by actuating the toolkit in step 316 which alerts annotation service 10 that changes are to be made to the content in step 318, and the user is prompted to make the annotation changes in step 320. The new/edited annotations are then uploaded and stored in annotation database 14 in step 322. The user is then free to logoff the annotation service 324 and the process ends.

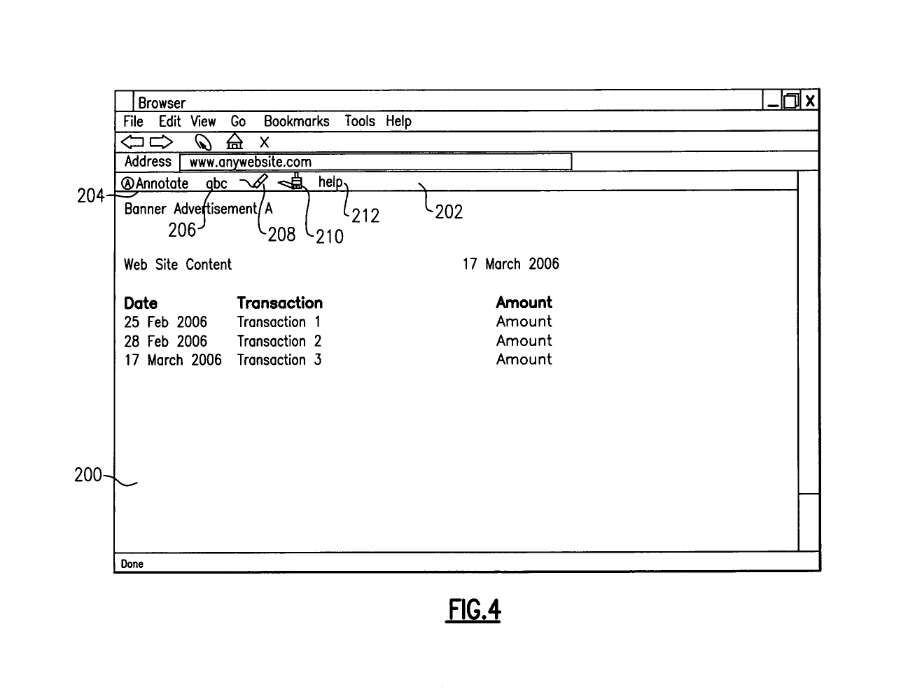

With reference to FIGS. 4-9, the series of user interfaces appearing on browser 200 as the user steps through the annotation service 10, as illustrated in flowchart of FIG. 3, is provided. FIG. 4 illustrates the user view of accessing a web site via annotation service 10 on 17 Mar. 2006, in this example, and the website is seen as not having any annotations associated with it, corresponding with step 314 on the flow chart of FIG. 3. The annotation toolbar 202 is presented to the user on browser 200. Toolbar 202 can be a toolbar in the browser control area (as illustrated), the browser display area, or in a separate window. Icons 204 (indication of actuation status of annotation tools), 206 (text), 208 (draw), 210 (highlight), and 212 (“Help” function) are used to represent examples of the various edit tools available with the annotation service. By double clicking with a mouse (or otherwise actuating the icons), the user is able to use the functionality represented by these icons.

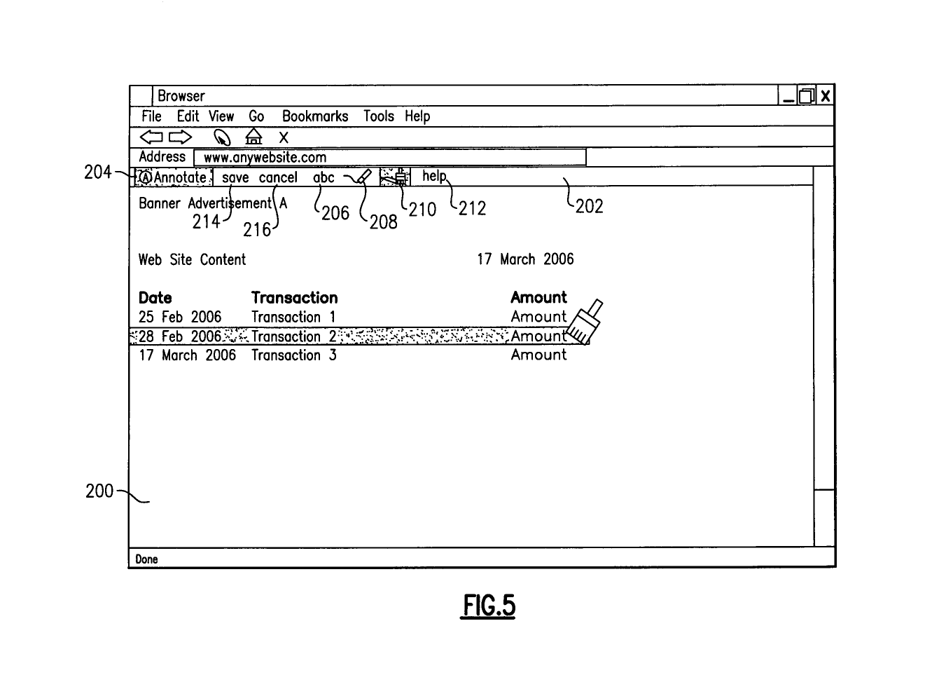

FIG. 5 is illustrative of the screen shot corresponding to steps 316-320 from the flow chart of FIG. 3 where the user has actuated the annotation toolbar 202 (by clicking icon 204) and is starting to add annotations to the page they are viewing. Once actuated, additional icons for saving 214 and canceling 216 the annotations are provided on toolbar 202. In the annotation example of FIG. 5, the user has actuated the highlight function by clicking on the paintbrush icon 210 on toolbar 202, and then using this “paintbrush” highlight tool to identify the field to be annotated; it is important to note that the annotation is being associated with the content (i.e., the data “28 Feb. 2006”) as opposed to the position on the screen (line 2 in the transaction list in this example). This relationship enables the content and annotation to be moved within the screen when the page is republished, hence not affecting the annotation for dynamic web pages.

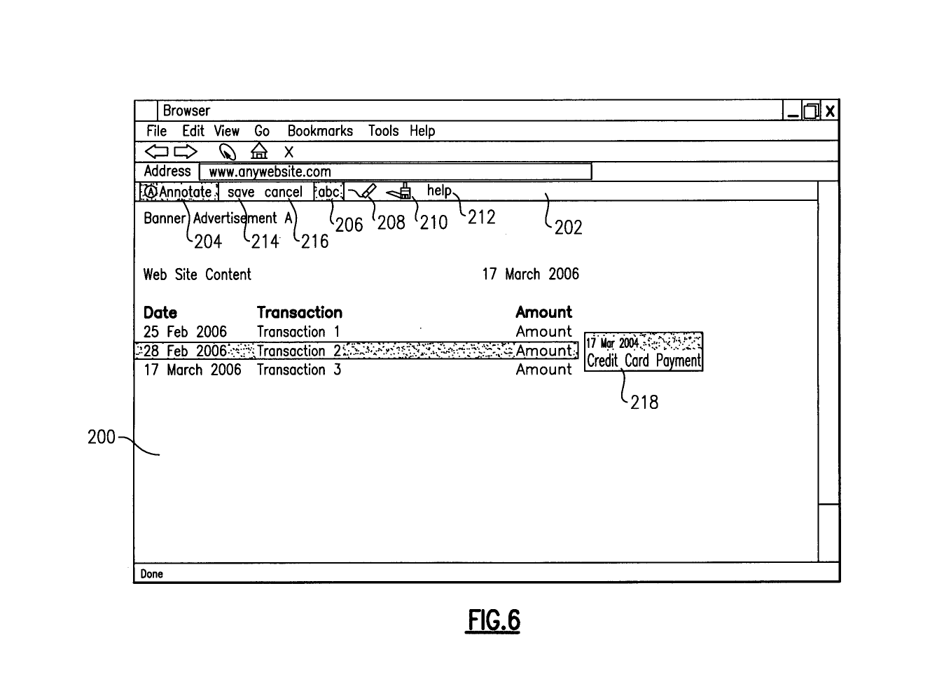

FIG. 6 is illustrative of the screen shot that corresponds with step 320 of the flow chart of FIG. 3 and illustrates a user adding textual details to the annotation 218 using the text tool actuated by clicking icon 206.

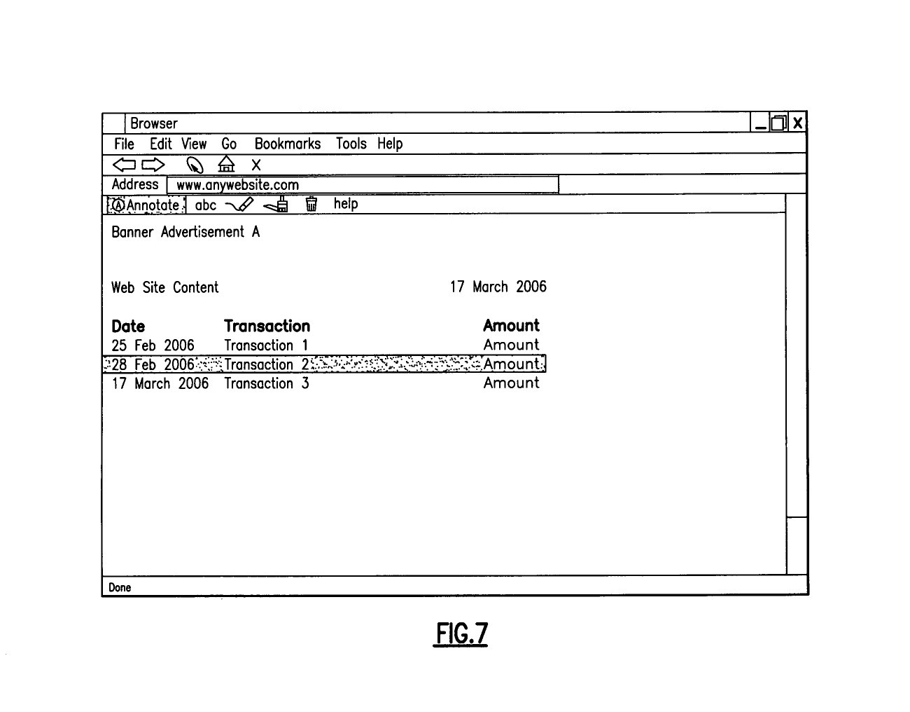

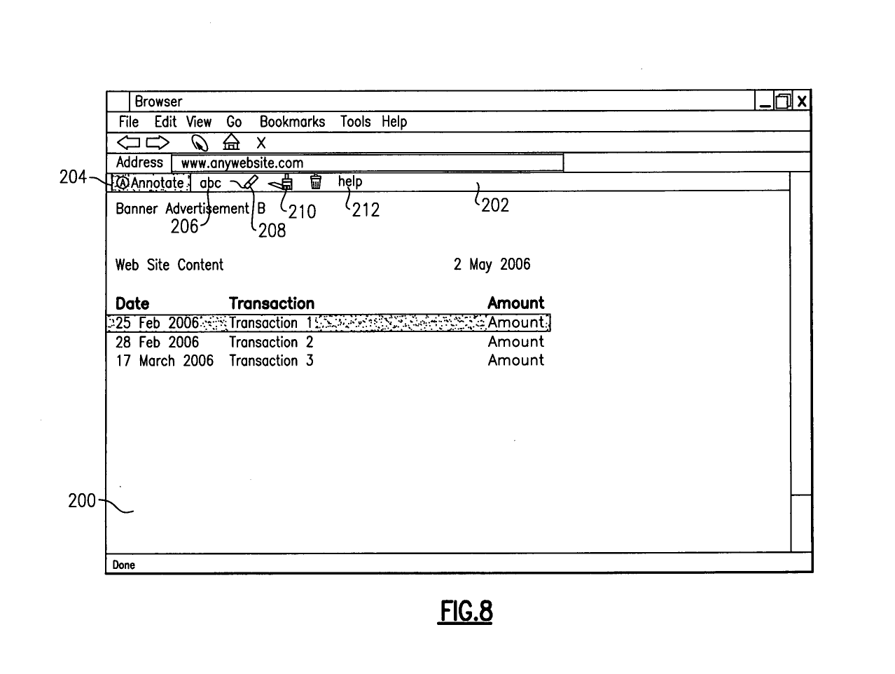

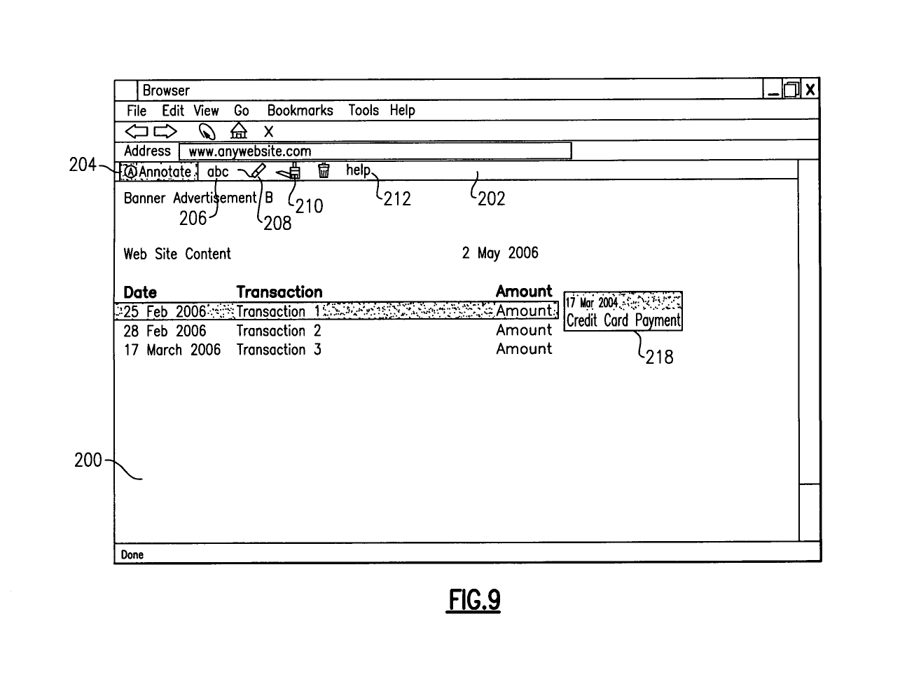

FIG. 7 is illustrative of the screen shot that corresponds with step 322 in the flow chart of FIG. 3, illustrating the look of the page immediately after the annotation has been saved (in this example on 17 Mar. 2006). FIG. 8 illustrates the same web page as in FIG. 7, but when accessed by the same user at a later date (in the example, 2 May 2006). As can be seen, because this page is dynamic (i.e. it is built every time the user accesses the URL), different content is displayed (e.g., the date is different and “Banner Advertisement B” appears instead of “Banner Advertisement A” that was present in FIG. 7), and content has moved about within the screen (for example, the annotated transaction is now on Line 1 and not Line 2 as it was in FIG. 7). The annotation service processing that occurs in steps 305, 308, and 310 in the flow chart of FIG. 3 have identified that there are stored annotations for this URL, what the annotations are, and where the annotations are to be overlaid. The annotation service 10 then produces the highlighting over the filed and actuates the annotation icon 204 on the toolbar 202 to alert the user that there are annotations for this field. FIG. 9 shows the screen after the user has retrieved the annotation 218 associated with the highlighted field.

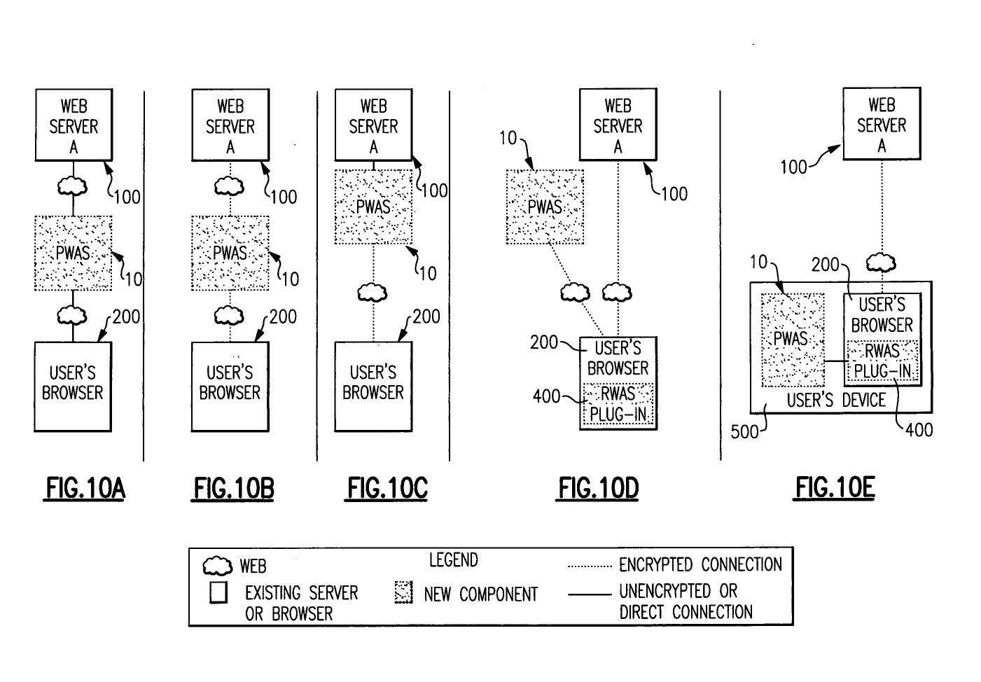

Referring now to FIGS. 10A-10E, several different architectures can be employed to deploy annotation service 10. In FIG. 10A a first embodiment is provided that positions the annotation service 10 in networked, non-encrypted communication between web server 100 and web browser 200. In the embodiment of FIG. 10B, annotation service 10 is also positioned in networked communication between web server 100 and web browser 200, but the connection with browser 200 is encrypted.

In the embodiment of FIG. 10C, annotation service 10 is illustrated as being a servlet of a web server 100. In this embodiment it would be necessary for any web site operator who desired to permit its users to access its content with the added functionality provided by annotation service 10 to have the annotation service embedded on its server 100; this obviously makes the annotation service “visible” to the web server 100.

In the embodiment of FIG. 10D, annotation service 10 is a dedicated server networked (encrypted connection) to browser 200 and browser 200 is also connected to server 100. Because there is not a serial connection through annotation service 10 in this embodiment, a Plug-In 400 (a “plug-In” being understood in the art as being a program, typically small in size, added to the browser program to enhance its functionality) must be added to browser 200 that adds the functionality to the browser of redirecting web server responses to the annotation service 10 for processing.

In the embodiment of FIG. 10E, the annotation service 10 is directly embedded in the user's computing device 500. Because the connection between browser 200 and web server 100 does not go through annotation service 10, plug-in 400 is also needed for this architecture.

While the present invention has been described with particular reference to those preferred embodiments disclosed herein, the invention should not be limited thereby, but rather be extended to its full scope and spirit as defined in the appended claims.

What is claimed is:

1. A method for annotating a web page comprising the steps of:
identifying a user in response to a logon request from said user;
intercepting a response from a web server from which a web page has been requested by said user;
determining if annotation data for said user is stored relative to said web page; and
providing said web page with any of said annotation data displayed thereon to said user.

2. The method for annotating a web page according to claim 1, further comprising the step of authenticating said user in response to said logon request from said user.

3. The method for annotating a web page according to claim 1, further comprising the step of associating said annotation data with a user defined field on said web page.

4. The method for annotating a web page according to claim 1, wherein the step of determining if annotation data for said user is stored relative to said web page includes the step of applying pattern matching to said web page.

5. The method for annotating a web page according to claim 1, comprising the further step of providing said user with the means for creating, editing, and saving annotations on a web page.

6. A system for annotating a web page, comprising:
a web page server
a web browser adapted to communicate with and request a predetermined web page from said web server;
a web page annotation system positioned in communication with at least said web browser and comprising an annotation server adapted to communicate with said web page server and said web browser, a pattern matcher adapted to communicate with said annotation server, and an annotation database adapted to communicate with said annotation server.

7. The system for annotating a web page according to claim 6, wherein said pattern matcher is a text search engine.

8. The system for annotating a web page according to claim 6, further comprising a customer database adapted to communicate with said annotation server.

9. The system for annotating a web page according to claim 6, wherein said web page annotation system includes an encrypted connection with said web browser.

10. The system for annotating a web page according to claim 6, wherein said web page annotation system is structured as a servlet on said web server.

11. The system for annotating a web page according to claim 6, wherein said web browser includes a plug-in for redirecting said web page received from said web server to said web page annotation system for processing.

12. The system for annotating a web page according to claim 11, wherein said web page annotation system is positioned remotely from said web browser.
The system for annotating a web page according to claim 1 1, further comprising a computer device in which said web browser is stored, and wherein said web page annotation system is also positioned within said computer device.

13. Web page annotation software stored on a computer readable medium, comprising:
means for identifying a user in response to a logon request made by said user;
means for receiving a response generated from a web server from which a web page has been requested by said user;
means for determining if annotation data is stored relative to said web page; and
means for providing said web page with any of said annotation data displayed thereon to said user.

14. The web page annotation software stored on a computer readable medium according to claim 13, wherein said means for determining if annotation data is stored relative to said web page comprises a text search engine.

15. The web page annotation software stored on a computer readable medium according to claim 1 3, further comprising means for permitting a user to create, edit and save annotations on a web page.

16. A web page annotation system positioned in communication with a web browser that is adapted for requesting a web page from a web server, comprising:
an annotation server adapted to communicate with said web page server and said web browser;
a pattern matcher adapted to communicate with said annotation server, and
an annotation database adapted to communicate with said annotation server.

17. The web page annotation system positioned in communication with a web browser that is adapted for requesting a web page from a web server according to claim 16, wherein said annotation server, said pattern matcher, and said annotation database are structured as a servlet on the web server.

18. The web page annotation system positioned in communication with a web browser that is adapted for requesting a web page from a web server according to claim 16, wherein said annotation server is adapted to communicate only with the web browser.

19. The web page annotation system positioned in communication with a web browser that is adapted for requesting a web page from a web server according to claim 16, wherein said annotation sever is adapted to communicate with the web browser and the web server.

20. The web page annotation system positioned in communication with a web browser that is adapted for requesting a web page from a web server according to claim 16, further comprising a customer database adapted to communicate with said annotation server.
